(19) United States
(12) Patent Application Publication
(10) Pub. No.: US 2017/0177060 A1
(43) Pub. Date: Jun. 22, 2017

(54) MICRO SERVER

(71) Applicants: INVENTEC (PUDONG) TECHNOLOGY CORPORATION, Shanghai City (CN); INVENTEC CORPORATION, Taipei City (TW)

(72) Inventor: Lanlan FANG, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 15/382,336

(22) Filed: Dec. 16, 2016

(30) Foreign Application Priority Data
Dec. 16, 2015 (CN) 201510947318.5

(51) Int. Cl. G06F 1/32; G06F 9/44; G06F 12/02; G06F 13/40

(52) U.S. Cl. CPC G06F 1/3221; G06F 13/4068; G06F 9/4401; G06F 1/3206; G06F 12/0246; G06F 2212/7206

(57) ABSTRACT

A micro server includes many server board modules. Each of these server board modules is individually located in a chasis to form a micro server system. Each server board module includes a mother board and a controller board. The mother board is used for executing the server operation system of the server board module. The controller board is plugged and electrically connected to the mother board. The controller board includes a PHY ethernet card, a micro controller, and a complex programmable logic device (CPLD). The PHY ethernet card is electrically connected to a remote management system. The micro controller is electrically connected to the PHY ethernet card and the mother board, respectively. The CPLD is electrically connected to the mother board and the micro controller, respectively.

### CROSS REFERENCE

The present application is based on, and claims priority from, China Application Serial Number 201510947318.5, filed on Dec. 16, 2015, the disclosure of which is hereby incorporated by reference herein in its entirety.

### TECHNICAL FIELD

The invention is related to a micro server, and particularly related to a micro server having satellite control modules.

### BACKGROUND

The micro server is a new server utilizing common infrastructure. The micro server has many low power-consumption servers therein, and the efficiency of the aforementioned structure is better than the efficiency of a structure utilizing a few high-efficiency servers. All server mother boards of one chasis of the micro server share the power device, the internet and the remote managing system so that the power consumption and the cost of heat dissipation are reduced.

However, it is necessary that each server mother board has its own managing system for ensuring the operation of the micro server which sharing the power. Hence, there is need for the improvement of the managing system of each server mother board in the micro server to ensure the efficiency of the common infrastructure of the micro server without setting too many managing elements.

### SUMMARY

A micro server according to one embodiment of the invention includes a plurality of server board modules, and each of the server board modules includes a mother board for executing a server operation system of the server board module, a controller board plugged in the mother board so as to be electrically connected to the mother board. The controller board includes a PHY Ethernet card, a micro controller and a complex programmable logic device (CPLD). The PHY ethernet card is electrically connected to a remote managing system and used for transferring a system signal to the remote managing system so that the server board module is capable of communicating with the remote managing system. The micro controller is electrically connected to the PHY ethernet card and the mother board, and the micro controller obtains a state signal from the mother board to generate the system signal and transfers the system signal to the remote managing system via the PHY ethernet card so that the remote managing system obtains the system signal of each of the server board modules for monitoring. The CPLD is electrically connected to the mother board and the micro controller, and equips with a system timing control module for providing timing control to the mother board.

In order to make the aforementioned and other features of the present disclosure more comprehensible, several embodiments accompanied with figures are described in detail below.

### BRIEF DESCRIPTION OF THE DRAWINGS

The present disclosure will become more fully understood from the detailed description given herein below for illustration only, and thus are not limitative of the present disclosure, and wherein:

FIG. 1A is a functional block diagram of a micro server according to the first embodiment of the invention;

FIG. 1B is a functional block diagram of a server board module of a micro server according to the first embodiment of the invention;

FIG. 2 is a functional block diagram of the second embodiment according to the invention;

FIG. 3 is a functional block diagram of the third embodiment according to the invention;

FIG. 4 is a functional block diagram of a server board module according to the fourth embodiment in the invention; and

FIG. 5 is a functional block diagram of a server board module according to the fifth embodiment of the invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

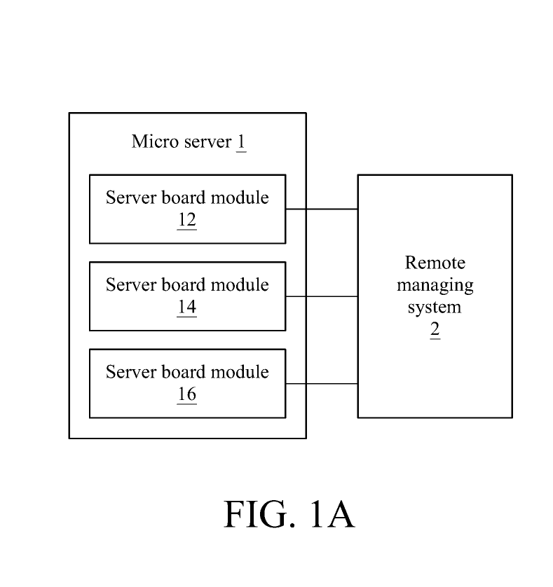

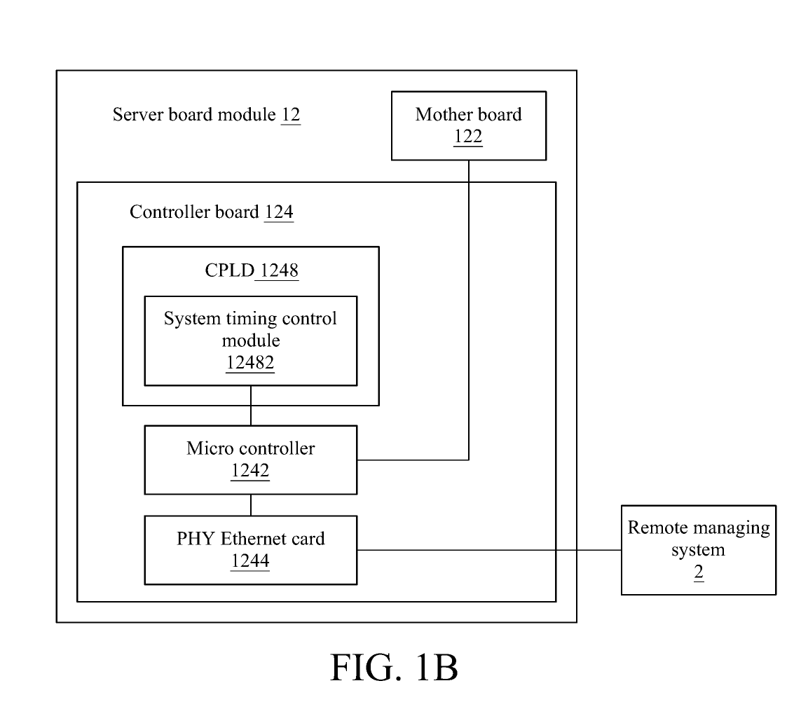

Please refer to FIG. 1A and FIG. 1B, wherein FIG. 1A is a functional block diagram of a micro server according to the first embodiment of the invention, and FIG. 1B is a functional block diagram of a server board module of a micro server according to the first embodiment of the invention. As show in FIG. 1A, the micro server 1 includes a server board module 12, a server board module 14, and a server board module 16. Each of the server board module 12, the server board module 14, and the server board module 16 is individually set in a chasis to form a micro server system. Additionally, only the server board module 12, the server board module 14, and the server board module 16 are illustrated in FIG. 1A, but the amount of the server board modules in a micro server 1 should not be limited to the illustrations. The structures of the server board modules 12, 14, and 16 may be identical or different from each other. In the embodiments below, the server board module 12 is taken as an example for understanding the spirit of the invention, but one having ordinary in the art is capable of understanding how to realize the server board module 14 or the server board module 16 according to the invention.

As shown in FIG. 1B, the server board module 12 includes a mother board 122 and a controller board 124. The controller board 124 is plugged and electrically connected to the mother board 122. In some embodiment, the controller board 124 communicates with the mother board 122 via a Serial Peripheral Interface Bus (SPI), a Low pin count Bus (LPC Bus) or a universal serial bus (USB).

The mother board 122 executes the server operation system of the server board module 12. The controller board 124 includes a PHY ethernet card 1244, a micro controller 1242, and a Complex Programmable Logic Device (CPLD) 1248. The PHY ethernet card 1244 is electrically connected to a remote managing system 2. The micro controller 1242 is electrically connected to the PHY ethernet card 1244 and the mother board 122. The CPLD 1248 is electrically connected to the mother board 122 and the micro controller 1242. In one embodiment, the CPLD 1248 has a system timing control module 12482.

The PHY ethernet card 1244 transferres the system signal to the remote managing system 2 so that the server board module 12 is capable of communicating with the remote managing system 2. The micro controller 1242 obtains the mother board state signal from the mother board 122 so as to generate the system signal. For example, the mother board state signal includes parameter of the working temperature, parameters of the working voltage, parameters of the working current, parameters of other parameters, or the combination of the aforementioned parameters. The micro controller 1242 transfers the system signal via the PHY ethernet card 1244 to the remote managing system 2 so that the remote managing system 2 is capable of obtaining and monitoring the system signal of the server board module 12. In other words, the user can obtain the information corresponding to the server board module 12 or giving commands to the server board module 12 by the interface provided by the remote managing system 2. In one embodiment, the PHY ethernet card 1244 communicates with the micro controller 1242 via a Media Independent Interface (MII). The micro controller 1242 communicates with the CPLD 1248 with a 16 bit digital/analog bus in one embodiment.

The system timing control module 12482 provides timing control for the mother board 122. In one embodiment, the system timing control module 12482 provides in-phase clock signals to the micro controller 1242 and the mother board 122 simultaneously, so the micro controller 1242 and the mother board 122 are capable of performing synchronous controls or other timing operations mutually.

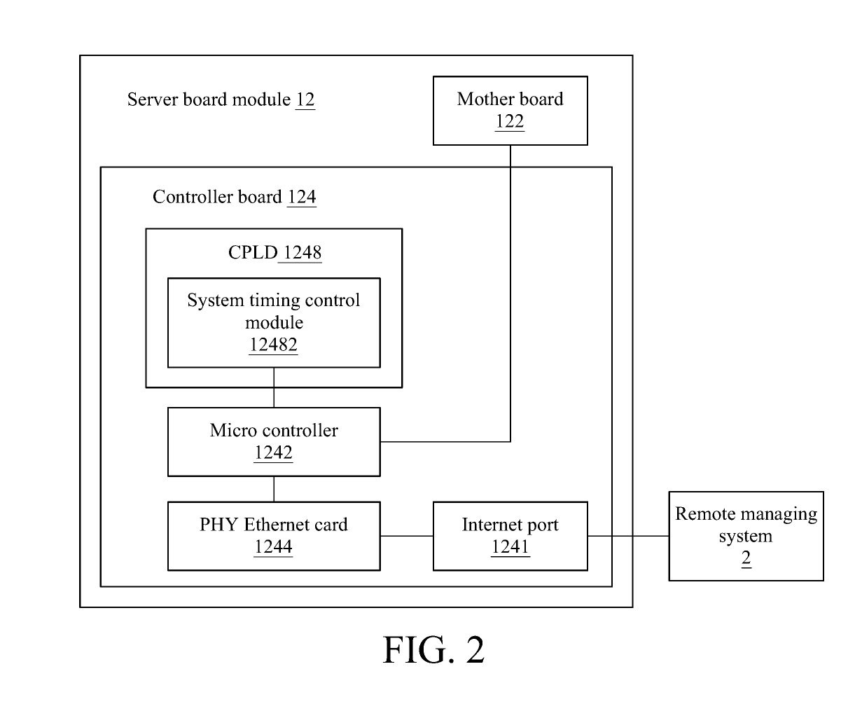

In another embodiment, the micro server 1 includes the remote managing system 2 therein. In the embodiment, the server board module 12, the server board module 14 and the server board module 16 are respectively electrically connected to the remote managing system 2, and the remote managing system 2 provides power and internet signal for the server board module 12, the server board module 14 and the server board module 16. In other words, the remote managing system 2 is part of the micro server 1. Please refer to FIG. 2, which is a functional block diagram of the second embodiment according to the invention. As shown in FIG. 2, the remote managing system 2 is part of the micro server 1. Additionally, the server board module 12 further has an internet port 1241 electrically connected to the PHY ethernet card 1244 and the remote managing system respectively. The server board module 12 communicates with the remote managing system 2 via the internet port 1241. In one embodiment, the internet port 1241 is pluggably connected to the mother board 122, and the server board module 12 communicates with the remote managing system 2 via the internet port 1241 and the channel of the mother board 122. The internet port 1241 is, for example but not limited to, a cartridge gold finger.

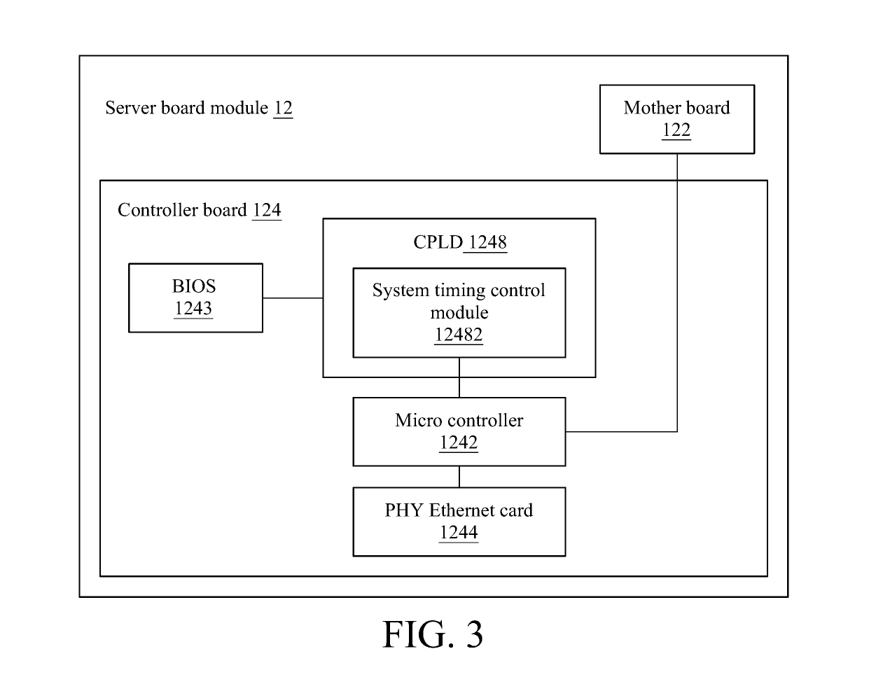

Please refer to FIG. 3, which is a functional block diagram of the third embodiment according to the invention. As shown in FIG. 3, the controller board 124 further includes a basic input/output system chip 1243 (BIOS chip 1243). The BIOS chip 1243 is electrically connected to the CPLD 1248. The BIOS chip 1243 stores the mother board configuration such as timing relationship configurations between elements on the mother board or other related configurations. In one embodiment, the CPLD 1248 reads the mother board configuration via the BIOS chip 1243 so as to perform a timing control for the mother board. In one embodiment, the micro controller 1242 communicates with the BIOS chip 1243 via a Serial Peripheral Interface (SPI).

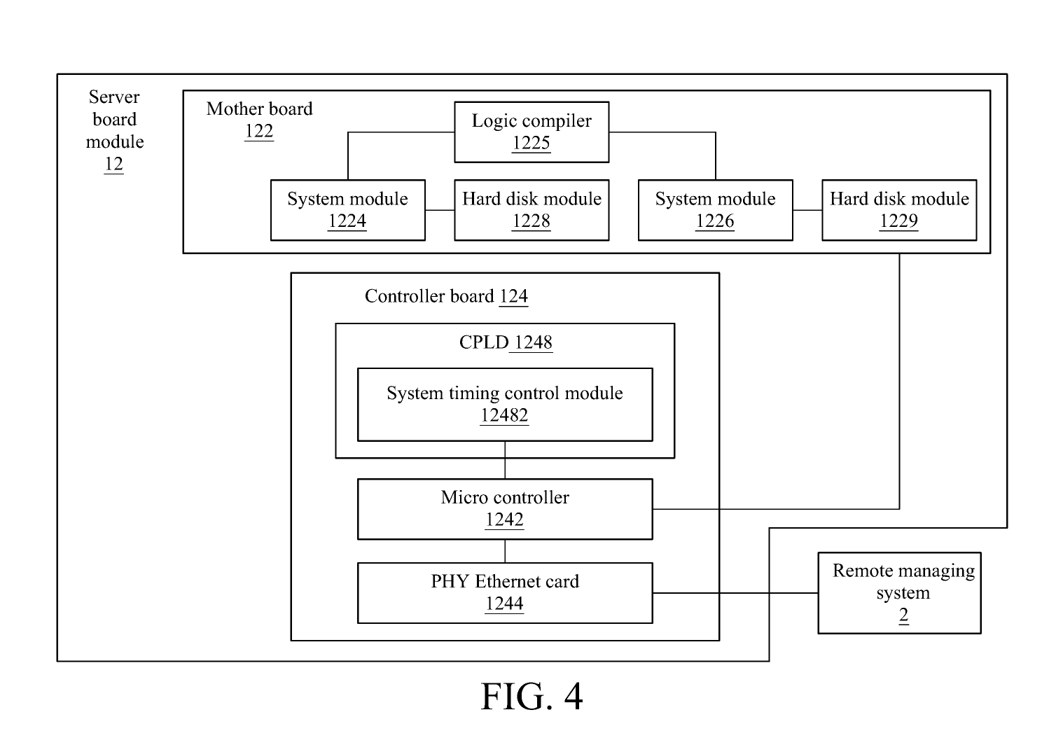

Please refer to FIG. 4, which is a functional block diagram of a server board module according to the fourth embodiment in the invention. As shown in FIG. 4, the mother board 122 further includes a system module 1224, a system module 1226, a logic compiler 1225, and two hard disk modules 1228 and 1229. The system module 1224 and the system module 1226 are respectively electrically connected to the logic compiler 1225. At least one of the system module 1224 and the system module 1226 is electrically connected to the controller board 124. At least one of the system module 1224 and the system module 1226 is electrically connected to the hard disk modules 1228 and 1229 so as to communicate with the controller board 124 and save the system data. In FIG. 4, the system module 1224 and the system module 1226 are respectively electrically connected to the controller board 124. The system module 1224 and the system module 1226 are also respectively electrically connected to the hard disk module 1228 and the hard disk module 1229. In one embodiment, at least one of the system module 1224 and the system module 1226 monitors or controls the controller board 124 based on the scheduling configuration or other needs. The system module 1224 and the system module 1226 are capable of saving data obtained from the controller board 124 in the hard disk module 1228 and the hard disk module 1229. This embodiment is for illustrating the spirit of the invention, and the amount of the system modules and the amount of the hard disk modules should not be limited to the embodiment of FIG. 4. Besides, the topology between the system modules and the hard disk modules is not limited in one-to-one.

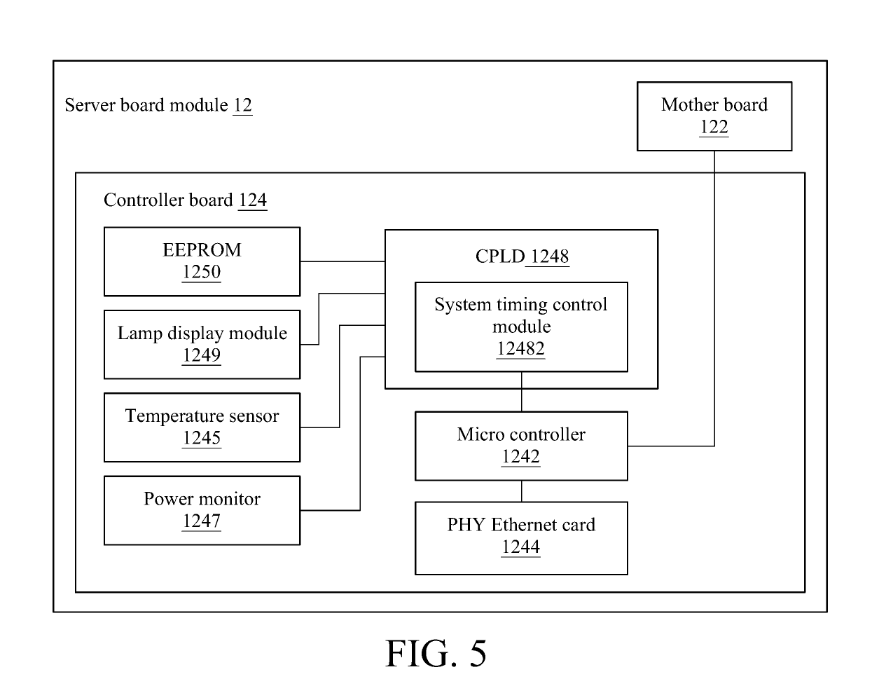

Please refer to FIG. 5, which is a functional block diagram of a server board module according to the fifth embodiment of the invention. As shown in FIG. 5, the controller board further includes a temperature sensor 1245, a power monitor 1247, a lamp display module 1249, and an electrically erasable read memory (EEPROM) 1250. The temperature sensor 1245, the power monitor 1247, the lamp display module 1249, and the EEPROM 1250 are respectively electrically connected to micro controller 1242.

The temperature sensor 1245 is used for sensing the working temperature of the server board module 12 where the controller board 124 is located so as to generate the temperature sensing data, and transferring the temperature sensing data to the micro controller 1242. The temperature sensing data is, for example, the working temperatures of the units in the server board module 12. The micro controller 1242 generates the mother board state signal based on the temperature sensing data. The power monitor 1247 is used for monitoring the power distribution of the server board module 12 where the controller board 124 is located, and providing the power distribution information to the micro controller 1242. The power distribution information is, for example, the power consumed by each unit in the server board module 12. The micro controller 1242 is capable of generating the mother board state signal based on the power distribution information. The micro controller 1242 saves and refreshes the hardware configuration data in the EEPROM 1250. The lamp display module 1249 is capable of receiving the mother board state signal, and selectively display the operation status of the server operation system of the server board module 12 where the lamp display module 1249 is located based on the information in the mother board state signal. The mother board state signal may include the working temperature value of the mother board or the power state of the mother board. The micro controller 1242 communicates with the EEPROM 1250, the temperature sensor 1245, and the power monitor 1247 via a inter-integrated circuit (I2C) in one embodiment.

As above, the invention discloses a micro server. The micro server has a controller board plugged into the mother board and electrically connected to the remote managing system so as to make the controller board act as an interface of communication between the remote managing system and the mother board. Additionally, the controller board is capable of obtaining a variety of monitoring information corresponding to the mother board so that the remote managing system is capable of obtaining the corresponding information and controlling the mother board. The user may control the mother board in each micro server via the remote managing system, so there is no need to set a complicated managing element on each of the mother boards. Therefore, the cost and the system power consumption are reduced.

What is claimed is:

1. A micro server, comprising a plurality of server board modules, and each of the server board modules comprises:
a mother board, for executing a server operation system of the server board module;
a controller board, plugged in the mother board so as to be electrically connected to the mother board, wherein the controller board comprises:
a PHY ethernet card, electrically connected to a remote managing system, and transferring a system signal to the remote managing system so that the server board module is capable of communicating with the remote managing system; and
a micro controller, electrically connected to the PHY ethernet card and the mother board, and the micro controller obtaining a state signal from the mother board to generate the system signal and transmitting the system signal to the remote managing system via the PHY ethernet card so that the remote managing system monitors the system signal of each of the server board modules ; and
a complex programmable logic device (CPLD), electrically connected to the mother board and the micro controller, and equipped with a system timing control module for providing timing control to the mother board.

2. The micro server of claim 1, wherein each of the server board modules is electrically connected to the remote managing system, and the remote management system provides power and internet signal for the plurality of server board modules.

3. The micro server in claim 1, wherein the mother board comprises:
a logic compiler;
a plurality of hard disk modules;
a plurality of system modules, respectively electrically connected to the logic compiler, wherein at least one system module is electrically connected to the controller board; and at least one among the system modules is electrically connected to the hard disk modules so as to communicate with the controller board and save a system data.

4. The micro server of claim 2, wherein the controller board further comprises an internet port electrically connected to the PHY ethernet card, and the controller board is pluggable connected to the mother board via the internet port to communicate with the remote management system.

5. The micro server of claim 1, wherein the controller board further comprises a basic input/output system chip (BIOS chip), and the BIOS chip is electrically connected to the CPLD and contains a mother board configuration, and the CPLD reads the mother board configuration via the BIOS chip to perform a timing control for the mother board.

6. The micro server of claim 1, wherein the controller board further comprises a temperature sensor electrically connected to the micro controller, and the temperature sensor is used for sensing a working temperature of the server board module corresponding the controller board to generate a temperature sensing data, and transferring the temperature sensing data to the micro controller, and the micro controller generates a mother board state signal based on the temperature sensing data.

7. The micro server of claim 1, wherein the controller board further comprises a power monitor electrically connected to the micro controller, and the power monitor is used for monitoring a power distribution of the server board module corresponding to the controller board and used for providing a power distribution information to the micro controller, and the micro controller generates a mother board state signal based on the power distribution information.

8. The micro server of claim 1, wherein the controller board further comprises an electrically-erasable programmable read-only memory (EEPROM), and the micro controller is electrically connected to the EEPROM save and refresh a hardware configuration data in the EEPROM.

9. The micro server of claim 1, wherein the controller board further comprises a lamp display module electrically connected to the micro controller and receiving a mother board state signal to indicate an operation status of the server operation system of the server board module corresponding to the display module, wherein the mother board state signal comprises a motherboard operation temperature value and a motherboard power state value.
